(19) United States
(12) Patent Application Publication
(10) Pub. No.: US 2015/0370266 A1
(43) Pub. Date: Dec. 24, 2015

(54) ACTIVE NOISE AND VIBRATION CONTROL SYSTEMS AND

(71) Applicant: LORD CORPORATION, Cary, NC (US)

(72) Inventors: Mark A. NORRIS, Cary, NC (US); Doug A. SWANSON, Cary, NC (US); Mark R. JOLLY, Raleigh, NC (US)

(21) Appl. No.: 14/767,215

(22) PCT Filed: Mar. 7, 2014
(86) PCT No.: PCT/US2014/021717

§ 371 Date: Aug. 11, 2015

Related U.S. Application Data
(60) Provisional application No. 61/775,317, filed on Mar. 8, 2013.

(51) Int. Cl. G05D 19/02; G05B 15/02; G10K 11/16

(52) U.S. Cl. CPC G05D 19/02; G10K 11/16; G05B 15/02; G10K 2210/129

(57) ABSTRACT

Active noise and vibration control (ANVC) systems and methods are provided. The systems and methods include providing sensors configured to detect vibration of a structure and a controller in electrical communication with the sensors. The controller includes a hardware processor and a memory element configured to process the vibration detected by the sensors, generate a force control command signal, and output the force control command signal via an interface. The systems and methods include provisions for at least one circular force generator (CFG) in electrical communication with the controller, the CFG is configured to execute the force control command signal output from the controller and produce a force that substantially cancels the vibration force. In some aspects, one or more CFGs control different vibration frequencies causing unwanted vibrations or acoustical tones. In some aspects, one or more CFG's control unwanted vibrations during some conditions and noise during other conditions.

### CROSS REFERENCE TO RELATED APPLICATION

This application relates to and claims priority to U.S. Provisional Patent Application Ser. No. 61/775,317, filed Mar. 8, 2013, the disclosure of which is incorporated by reference herein in the entirety.

### TECHNICAL FIELD

The subject matter herein generally relates to the field of noise and/or vibration control of structures subjected to one or more vibration forces. The subject matter herein more particularly relates to active noise and omnidirectional vibration control of structures provided in a steady and transient environment, such as a fixed wing and tilt rotor aircraft during the various stages of flight, including take-off and landing.

### BACKGROUND

Structures can vibrate at many different frequencies. For example only and without limitation, it is common for jet and/or turboprop engines of a fixed wing aircraft to impart different vibrational frequencies due to mass imbalances within the engines or due to the propeller pressure waves on the fuselage. The vibrations manifest in measurable vibratory movement and/or acoustical noise. This can be damaging and/or discomforting with respect to structures and occupants of the aircraft. Similarly, vibration and acoustical noise may be induced or manifest in other systems, such as any vehicle, tiltrotor aircraft, helicopter, hovercraft, truck, train, aircraft, building structure, etc.

In addition to the jet and/or turboprop engines, other vibrations are imparted to the aircraft via equipment including, for example, pumps, generators, turbulence, aero-elasticity flexing, etc. The additional vibrations provide structural vibrations and create interior and/or exterior acoustical noises. These additional vibrations occur at a variety of different frequencies, and are additive to overall vibratory and acoustical forces imparted to the example aircraft.

To adapt for the engine related vibration frequencies, some aircraft and engine manufacturers modify the engine speed to avoid acoustic or structural resonances, which result in high vibration and/or acoustical noise. Unfortunately, this crude attempt at vibration control also creates wasteful and expensive excess fuel burn conditions.

Existing vibration control systems are linear and require pre-tuning for a specific frequency or frequency range. Because these systems are typically tuned for a single frequency, they are heavy and negatively impact the weight of the aircraft. The capability to generate omnidirectional vibration control in multiple spherical directions across the multiple frequencies currently does not exist.

Accordingly, there is a need for a lighter weight active noise and vibration control (ANVC) systems and methods for controlling vibrations across multiple frequencies with multiple frequency inputs, including acoustical inputs, and to provide vibration control omnidirectionally, in at least one or more spherical vectors.

### SUMMARY

The subject matter herein provides for an active noise and vibration control (ANVC) systems and methods of controlling vibrations and/or acoustical noise associated with a vibrating structure.

In one aspect, an ANVC system is provided. The system includes a plurality of sensors configured to detect vibration of a structure and a controller in electrical communication with each of the plurality of sensors. The controller includes a hardware processor and a memory element configured to process the vibration detected by the plurality of sensors, generate a force control command signal, and output the force control command signal via an interface. The system further includes at least one circular force generator (CFG) in electrical communication with the controller, wherein the CFG is configured to execute the force control command signal output from the controller and produce a force that substantially cancels the vibration force. As described herein, the controller receives input regarding noise and vibration from the sensors, and actively controls the noise and vibration by activating the CFGs, which are configured to counteract and substantially cancel the perceived noise and vibration.

Another embodiment of an ANVC system is provided. The ANVC system includes a plurality of sensors configured to detect vibration of a structure and a controller. The controller is in electrical communication with each of the plurality of sensors and includes a hardware processor and a memory element configured to process the vibration detected by the plurality of sensors. The system includes a single CFG in electrical communication with the controller. The CFG is configured to spin a pair of eccentric masses at one of several different frequencies (e.g., each spins together at a same frequencies, however, the frequency can be changed) for controlling two different frequencies of vibration. The controller, or a servo controller housed within the CFG, specifies the frequencies at which the CFG spins the eccentric masses.

A method of controlling acoustic noise and vibration is provided. The method includes providing a plurality of sensors for detecting vibration of a structure and digitally linking each sensor of the plurality of sensors with a controller. The controller includes a hardware processor and a memory element configured to process the vibration detected by the plurality of sensors, generate a force control command signal, and output the force control command signal via an interface. The method further comprises spinning a pair of eccentric masses within a rotary actuator according to the force control command signal output from the controller for producing a force that substantially cancels the vibration force.

Numerous objects and advantages of the subject matter will become apparent as the following detailed description of the preferred embodiments is read in conjunction with the drawings, which illustrate such embodiments.

### BRIEF DESCRIPTION OF THE DRAWINGS

FIG. 1 is a schematic illustration of one embodiment of an Active Noise and Vibration Control (ANVC) system for controlling noise and vibration of a structure.

FIG. 2 is a schematic illustration of another embodiment of an ANVC system for controlling noise and vibration of a structure.

FIG. 3 is a schematic illustration of another embodiment of an ANVC system for controlling interior noise and vibration of a structure.

FIG. 4 is a graph illustrating a representative circular force generated per circular force generator (CFG).

FIG. 5 illustrates imbalance masses of each CFG in zero force and full force positions.

FIGS. 6A and 6B illustrate plan view and front views, respectively, of a dual-engine jet aircraft.

FIG. 7 is a front view of a turboprop aircraft.

FIG. 8A is a front view of a tiltrotor aircraft in helicopter mode.

FIG. 8B is a front view of a tiltrotor aircraft in airplane mode.

### DETAILED DESCRIPTION

Reference is made in detail to the present embodiments of the subject matter, examples of which are illustrated in the accompanying drawings. For ease of understanding, the example of a jet aircraft having two engines is used. However, it is understood that any vehicle or structure subjected to one or more vibrational forces, which result in unwanted vibration and/or acoustical noise, can be substituted for the example jet aircraft.

As used herein, the term “controller” refers to a physical device including hardware in combination with software and/or firmware. A controller includes at least one hardware processor, at least one memory element, at least one input interface, and at least one output interface for sending and receiving signals between components of a system, such as sensors and rotary actuators (e.g., circular force generators, hereinafter referred to as “CFGs”).

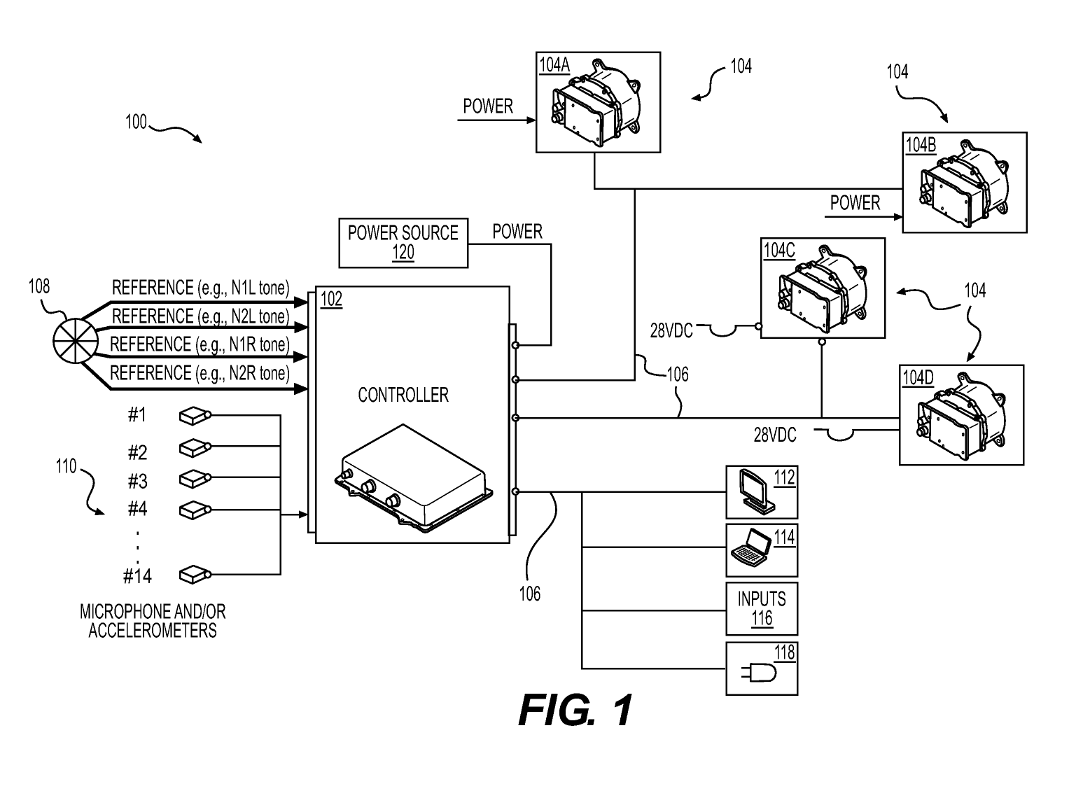

Referring now to FIG. 1, a first embodiment of an Active Noise and Vibration Control (ANVC) system, generally designated 100, is illustrated. In some aspects, system 100 actively senses vibration of a structure during steady and transient conditions and incorporates omnidirectional vibration control via one or more rotary actuators or CFGs for cancelling the vibration forces affecting the structure. The structure subjected to vibrating forces may include any one of a fuselage structure, an engine structure, any structure of a dual or twin engine jet aircraft, any structure of a turboprop aircraft, a tiltrotor aircraft, a ship structure, a building structure, a helicopter structure, hovercraft structure, a semi-truck structure, a train structure, any vehicle structure, etc.

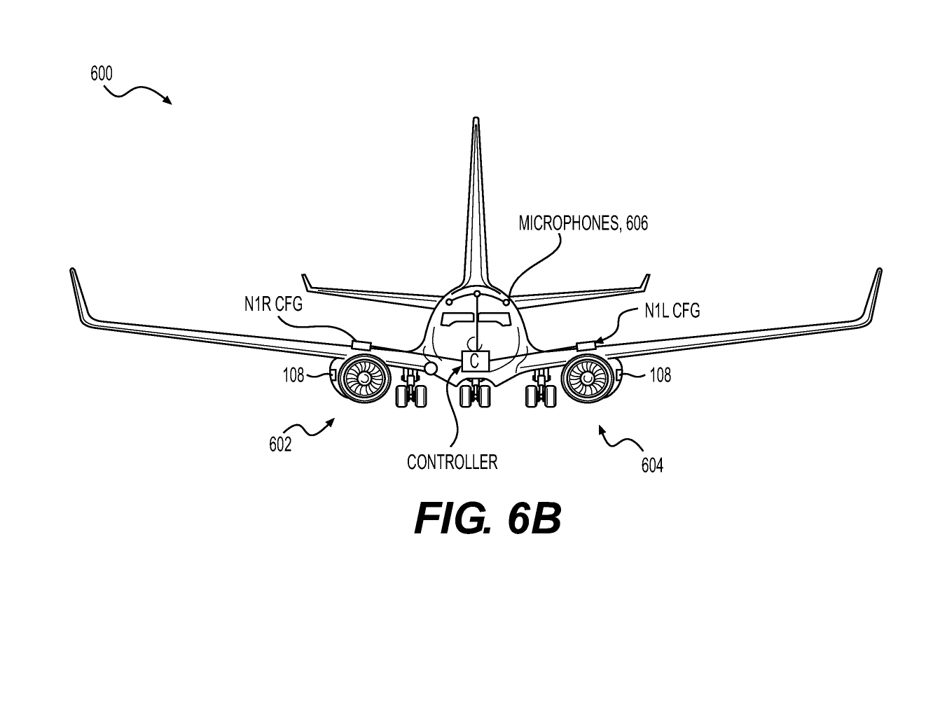

In some aspects, system 100 is configured to control interior vibration and acoustical noise within a cabin of dual engine jet aircraft (e.g., see FIGS. 6A and 6B). In this example, acoustic noise and dynamic vibration are created within an aircraft cabin due to rotational unbalances associated with aircraft engines on both sides of the fuselage cabin. In fuselage-mounted aircraft engines, the rotational unbalances cause vibration to be transmitted into the aircraft fuselage, which may be discomforting to passengers. Although controlling noise and vibration associated with aircraft structures is, for illustrative purposes, shown and described, system 100 can be used for actively reducing and/or controlling vibration and acoustical noise associated with any vibrating structure as noted above including any vehicle, tiltrotor aircraft, helicopter, hovercraft, truck, train, aircraft, building structure, etc.

Vibration transmitted to an aircraft fuselage may couple with an acoustic space of the aircraft cabin and generate annoying and/or damaging, predominantly tonal acoustic noise (generally characterized as an irritating drone) within the fuselage. In jet aircraft, the drone generally corresponds to the most dominant engine tones or tonal vibration, for example, the tones created via the N1 and N2 engine rotations or vibrations. “N1” and “N2” denote vibrations or tones generated by rotational unbalances of the turbine (fan) and compressor stages (compressor), respectively, of each of the left and right jet engine. Elimination of the N1 (e.g., fan) and N2 (e.g., compressor) engine vibrations dramatically reduces the discomfort experienced by the passengers of the aircraft. In some aspects, system 100 is configured to detect vibration and noise within the aircraft that is associated with the dominant N1 or N2 engine vibration or tone, and utilize a single CFG for cancelling noise and vibration of the dominant tone. In other aspects, system 100 utilizes multiple CFGs for simultaneously cancelling noise and vibration of multiple tones. Notably, system 100 is configured to control vibration and noise within both steady and transient environment during the various stages of flight, including take-off, cruise, and landing. Transient conditions and transient environments are associated with a transient change of vibration and/or acoustical noise. In the aircraft example, these transient conditions and transient environments include the transition from taxi to take-off, climb to altitude, cruise, descent and landing. In the non-aircraft example, transient conditions and transient environments include changes the noise inducing system is subjected to by the real or artificial environment.

As illustrated in FIG. 1, system 100 includes a controller 102 and a plurality of vibration control devices such as rotary actuators or CFGs, generally designated 104. Individual CFGs 104A, 104B, 104C and 104D are each configured to co-rotate a pair of eccentric masses for cancelling or reducing the N1 and/or N2 vibration and noise per instructions received from controller 102. Controller 102 is centralized within an aircraft and with respect to CFGs 104. In some aspects, controller 102 and CFGs 104 electrically communicate via one or more data busses or data links 106. In some aspects, data links 106 include a digital link for providing communications between components of system 100 via a communications protocol (e.g., Ethernet, RS232, CAN, RS422, ARINC429, etc.), thereby allowing components such as controller 102 and CFGs 104 to share information with each other relating to vibration control and status.

Controller 102 includes a hardware processor and memory for executing instructions, algorithms, and/or processing data or information. Controller 102 also includes a plurality of input and output communication interfaces. Controller 102 receives input signals from a plurality of sensors, determines vibration and noise levels, generates force cancelling control signals or commands, and outputs the force control signals or commands to vibration control devices, such as CFGs 104. CFGs 104 receive and execute the control commands thereby actively and dynamically cancelling vibration and mitigating noise during transient conditions, such as transient flight conditions. System 100 utilizes real-time sensor information received and processed at controller 102 for actively rotating CFGs 104 for generating vibration cancelling forces until a desired level of vibration and/or noise is achieved.

System 100 further includes a plurality of sensors. Sensors include reference sensors 108 and/or detection sensors 110, each of which electrically communicates with controller 102. Reference sensors 108 ensure that vibration and/or acoustical noise of a structure is controlled at a frequency correlated therewith. Detection sensors 110 detect and transmit real-time transient information regarding a vibrating structure. Communication between the plurality of sensors (e.g., 108 and 110) and controller 102 is through a direct electronic connection/link, an electronic communications bus, or a wireless link.

In some aspects, one or more reference sensors 108 are associated with at least one engine for providing at least one reference signal selected from the group consisting of a first reference signal indicative of an N1 fan rotation and a second reference signal indicative of an N2 compressor rotation. Controller 102 processes the reference signals and signals obtained from reference sensors 108 and detection sensors 110 according to a control algorithm, such as Least Mean Square (LMS) algorithm with or without control filters. Controller 102 outputs control signals or commands to actuate rotation of masses housed within CFGs 104. The ensuing effect is control of vibration associated with N1 and/or N2 engine vibration, which resultantly controls acoustic noise and/or vibration within the aircraft cabin. Reference sensors 108 are positioned to detect a known vibration from a component (e.g., an engine) mechanically attached to the vibrating structure (e.g., a fuselage).

For example and in some aspects, system 100 controls interior noise and vibration at a left engine's N1 fan and N2 compressor and at a right engine's N1 fan and N2 compressor using a single controller 102 and along with at least two reference sensors 108 per engine. That is, in some aspects, a pair of reference sensors 108 communicates N1 and N2 fan and compressor engine vibrations, respectively, generated at a left engine (i.e., designated “N1L” and “N2L”) and another pair at a right engine (i.e., designated “N1R” and “N2R”) to controller 102. Each reference sensor 108 identifies a tone (e.g., N1 or N2) and controller 102 associates that tone with at least one CFG 104. Controller 102 uses reference signals communicated from sensors 108 for determining and cancelling vibration and/or acoustical noise or tones via CFGs 104 associated with the tones.

In some aspects, a single and different CFG 104 controls vibration and/or noise associated with each N1 or N2 frequency per engine. For example, a first CFG 104A is configured to control the N1L tone, a second CFG 104B is configured to control the N2L tone, a third CFG 104C is configured to control the N1R tone, and a fourth CFG 104D is configured to control the N2R tone. In other aspects, multiple CFGs are used to control each N1 and N2 tone. Frequency and/or tones N1 and N2 include the acoustical pitch or vibration caused by a particular input, such as the engine fan at first tone N1 or high-speed turbine compressor at second tone N2.

In some aspects, reference sensors 108 include accelerometers or tachometers provided at each engine. Reference signals indicative of the N1L, N1R, N2L, and N2R engine vibrations are derived and communicated to controller 102. Controller 102 then controls noise and vibration via actuation or spinning of eccentric masses housed within CFGs 104 associated with each reference signal. Reference sensors 108 may attach to engine casings at appropriate points for picking up and transmitting the N1 and N2 vibration reference signals for each of the left and right engine. The appropriate points may be anywhere on an outer case at a rigid structural point on the engine. The reference signals may be provided to controller 102 via reference cables, and each signal may include vibrational contributions from N1 superimposed with N2 vibrations. The signals may optionally be amplified to an appropriate voltage level and filtered for filtering out unwanted frequency information and preventing aliasing. Notably, reference signals may be sampled or detected in real-time during transient flight conditions, including landing and take-off, such that vibration and noise are actively controlled.

Still referring to FIG. 1, system 100 and includes a plurality of detection sensors 110. Detection sensors 110 are configured to detect physical or environmental parameters, which impact vibration and acoustical noise. For example, detection sensors 110 may include microphones, tachometers, strain gauges, thermocouples, and/or additional accelerometers. Detection sensors 110 are configured to detect and transmit transient information available on or from the structure (e.g., a vibrating structure including a jet engine or turboprop engine aircraft structure, a helicopter, a building, a ship, a truck, a train, etc.).

For example, only and in some aspects, detection sensors 110 detect and transmit information regarding external atmospheric conditions, tachometer data, speed indicator data, and/or percent engine thrust data. In the case of the example aircraft, such information may include data indicating the transient conditions such as an angle of attack, take-off profile information, landing profile information, or the configuration of aircrafts slats, elevators, landing gear, or other related components that may cause vibrations or acoustical noise to be imparted to the structure of the aircraft. Similar types of external vibration and acoustical noise source generators exist for most any structure and are too numerous to list, but are considered as inputs of vibration and acoustical noise.

Reference sensors 108 provide a persistent signal indicative of the vibration disturbance frequency and sense a harmonic of the rotating speed of the rotating engine member producing vibration and noise (e.g., indicative of N1 fan and N2 compressor vibration). Detection sensors 110 are placed at points on or within the structure to detect an aggregate vibration and/or acoustical noise at predetermined locations. In some aspects, detection sensors 110 include microphones placed about the cabin of an aircraft. Microphones provide signals indicative of the residual noise at various locations about the aircraft cabin. Signals from detection sensors 110 are also processed at controller 102 and factored into the generated force commands or drive signals of the appropriate phase and magnitude (anti-vibration) for communication to CFGs 104 for reducing vibration transmission from the engine to aircraft structures and resultantly controlling and/or reducing the interior acoustic noise.

In some aspects, signals from reference sensors 108 and detection sensors 110 collectively indicate the vibration and/or acoustical noise of a structure, and are transmitted to controller 102. Data from reference sensors 108 is communicated to controller 102 and compared therein to data from detection sensors 110. Controller 102 generates an appropriate force control command or drive signal for achieving vibration and/or acoustical noise cancellation. The force control command or drive signal is transmitted directly to rotary actuators including CFGs 104, and implemented at the CFGs. CFGs 104 spin eccentric masses at different speeds, phase angles, frequencies, and/or magnitudes according to signals from controller 102 for generating forces for cancelling or greatly reducing N1 and N2 vibration (e.g., N1L, N2L, N1R, N2R, etc.) and noise.

As FIG. 1 further illustrates, system 100 may further include one or more optional input sources and/or output sources in electrical communication therewith. For example, system 100 may optionally include a cockpit interface 112 for receiving manual instructions or signals from a pilot within the cockpit. Such signals may be communicated via a digital bus, interface, or data link 106. System 100 may also comprise an optional maintenance interface 114, optional discrete inputs 116, and optional relay outputs 118. Controller 102 is lightweight, dimensionally compact, and includes an advantageous low power design configured to receive and use approximately 28 volts-DC (VDC) from a power supply such as an aircraft power supply or power source 120. Each CFG 104 is also configured to receive approximately 28 VDC of power either from power source 120 directly or through controller 102.

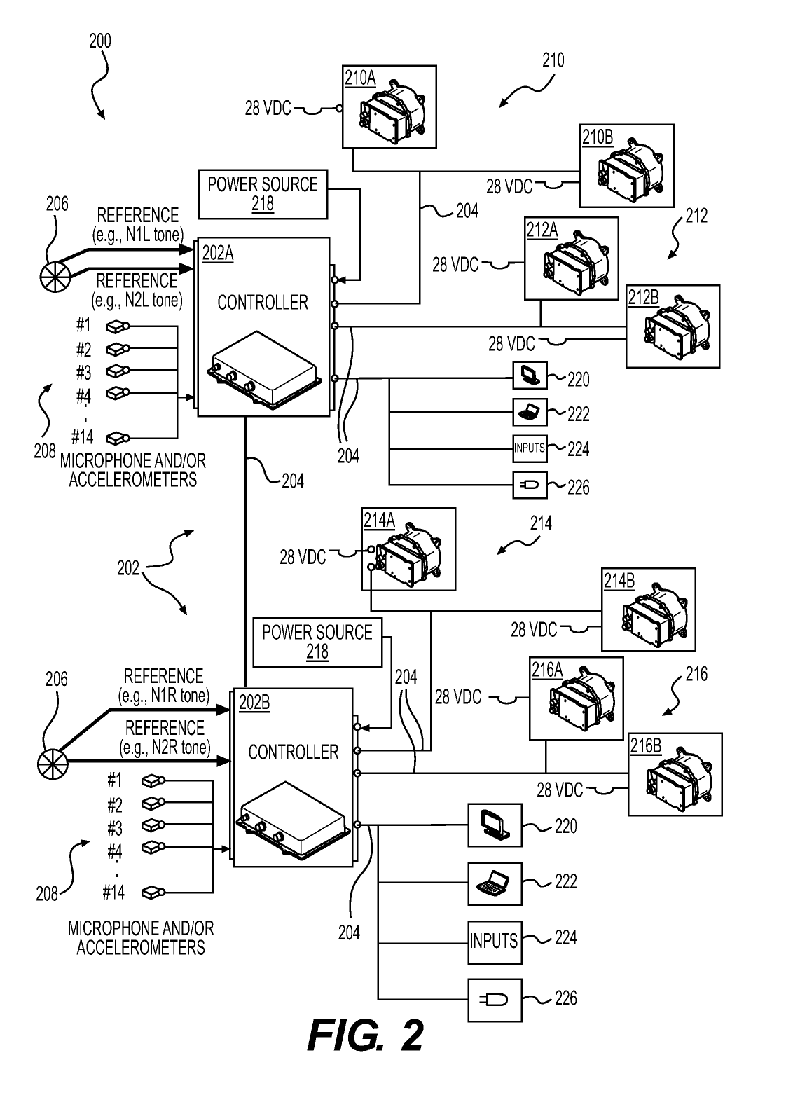

FIG. 2 is a schematic illustration of another embodiment of an ANVC system, generally designated 200, for controlling noise and vibration of a structure. System 200 includes at least two controllers, generally designated 202 for actively implementing noise and omnidirectional vibration control. Controllers 202 include a first controller 202A and a second controller 202B. In this embodiment, multiple controllers are digitally connected via data bus or digital data link 204 for expanding controller capability. System 200 is expanded to add, for example, more sensor or CFG channels. A system having more than two controllers 202 is also contemplated.

Controllers 202 pass information such as sensor data, tachometer data, force data, and status back and forth via link 204 to each other to efficiently maximize the vibration and/or noise cancellation. In this embodiment, controllers 202A and 202B are networked controllers and provide vibration and/or noise cancelling information to the applicable CFGs based upon the various input from the sensors. The use of two or more controllers, and the use of a controller with each CFG provides for a distributed architecture of controllers.

System 200 includes multiple CFGs for providing vibration cancelling forces at the N1 and N2 frequencies during at least some transient flight regimes, such as climb and descent based on the vibration and/or acoustical noise cancellation demands received from controllers 202. In some aspects, first controller 202A implements controller over two pairs of CFGs, generally designated 210 and 212. Similarly, second controller 202B implements controller over two pairs of CFGs, generally designated 214 and 216. In some aspects, first controller 202A implements noise and omnidirectional vibration control over one engine (e.g., the left or right engine). Second controller 202B implements control over the other engine (e.g., the remaining left or right engine). In some aspects, each pair of CFGs 210A and 210B, 212A and 212B, 214A and 104, and 216A and 216B, respectively, is configured to implement controller over one tone. For example, a first pair of CFGs 210A and 210B is configured to control the N1L tone, a second pair of CFGs 212A and 212B is configured to control the N2L tone, a third pair of CFGs 214A and 214B is configured to control the N1R tone, and a fourth pair of CFGs 216A and 216B is configured to control the N2R tone. Thus, multiple CFGs are used to control vibration and noise associated with different tones or frequency levels.

System 200 further includes a plurality of sensors including reference sensors 206 and a plurality of detection sensors 208. Reference sensors 206 provide reference signals to each controller 202 which are indicative of vibration of a structure, such as N1 fan vibration and N2 compressor vibration associated with an aircraft engine. Reference signals from reference sensors 206 are representative of a frequency and/or magnitude of the N1 and N2 engine vibrations/rotations for each of the left and right engines. Reference sensors 206 may include tachometers or accelerometers provided at each engine for deriving signals indicative of N1 engine fan vibration and N2 engine compressor vibration. Separate reference sensors 206 may provide the signal indicative of N1 and N2 vibration for each engine (e.g., the left and right engines).

Detection sensors 208, up to N total (where N is an integer >1), are provided throughout the cabin of the aircraft, and communicate signals representative of acoustic noise to controllers 202. Detection signals 208 may be placed in a plane at a height corresponding to an average passengers' head height or thereabouts on either side of the aircraft cabin. Optionally, accelerometers may be used as the detection sensors 208.

Filters, such as a low pass filter, high pass filter, band pass filter, or combinations thereof, may be used to filter out signal portions outside the frequency range of control to provide relatively noise-free detection signals (containing only frequency information within the control frequency range). A converter (not shown) may optionally be used to convert the analog signal into a useable digital form to be processed in digital form by the digital electronic controllers 202. Detection signals may be sampled at either a constant or a variable sampling rate for providing active vibration control.

As FIG. 2 further illustrates, system 200 may further include one or more optional input sources and/or output sources in electrical communication therewith. For example, system 200 may optionally include a cockpit interface 220 for receiving manual instructions or signals from a pilot within the cockpit. Such signals may be communicated via a digital bus, interface, or data link 204. System 200 may also comprise an optional maintenance interface 222, optional discrete inputs 224, and optional relay outputs 226. Controllers 202 are lightweight, dimensionally compact, and include a low power design configured to receive and use approximately 28 VDC from an aircraft power supply or power source 218. Each CFG is also configured to receive approximately 28 VDC of power either from power source 218 directly or through controller 202.

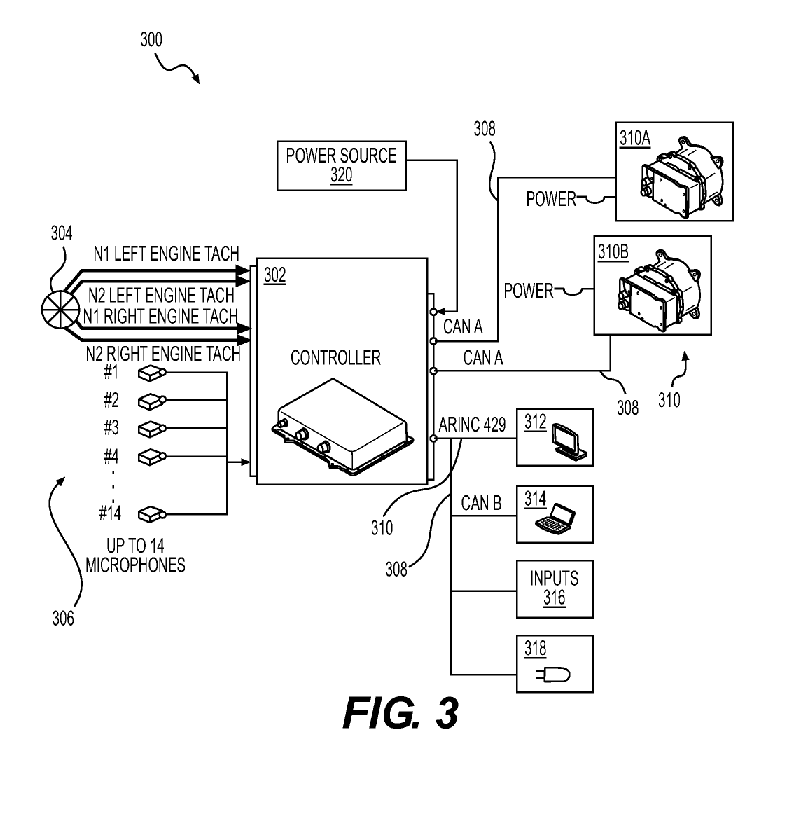

FIG. 3 is a schematic illustration of another embodiment of an ANVC system, generally designated 300, for controlling interior noise and vibration of a structure. System 300 includes a single controller 302 receiving signals from a plurality of reference sensors 304 and detection sensors 306. Signals from reference sensors 304 are indicative of vibration of a structure, for example, of N1 or N2 fan and compressor engine vibrations, respectively, of a dual engine aircraft. Signals from detection sensors 306 are indicative of acoustical noise caused by vibration. Controller 302 processes reference signals from sensors 304 and detection signals from sensors 306 and implements vibration control by sending drive signals to a plurality of CFGs 310. CFGs 310 spin or co-rotate eccentric masses for counteracting and/or cancelling engine vibration.

Controller 302 is digitally linked to sensors and CFGs 310 via data busses or digital data links 308. As FIG. 3 illustrates, data links 308 include a digital link for providing communications between components of system 300 via a communications protocol such as CAN A, CAN B, and/or ARINC429, for allowing components such as controller 302 and CFGs 310 to share information with each other relating to vibration control and status.

In some aspects, only a single CFG 310 is provided per engine for controlling vibration at either the N1 or the N2 tone as instructed by controller 302. That is, each CFG 310 is configured to produce N1 and N2 vibration cancelling forces at different times for accommodating noise and vibration during transient conditions. For example, a first CFG 310A is provided at a first engine (e.g., the left or right) and a second CFG 310B is provided at the other engine. The first and second CFGs 310A and 310B cancel noise and vibration associated with N1 or N2 engine vibration as instructed from controller 302. Providing only one CFG per engine is advantageous, as weight of system 300 is greatly reduced. Controller 302 uses reference signals communicated from sensors 304 and 306 for determining a dominant vibration and/or acoustical noise and for cancelling the dominant vibration via CFGs 310.

In some aspects, controller 302 includes a processor and memory for executing an algorithm stored therein. The algorithm is used to determine the dominant vibration (e.g., N1 or N2) or acoustical tone during a given flight condition, generate a force command or signal, and communicate the signal to each CFG 310. In some aspects, controller 302 determines whether noise and/or vibration associated with a fan speed (N1) or a compressor speed (N2) is more dominant, and instructs CFGs 310A and 310B accordingly. Controller 302 slows or speeds CFGs 310A and 310B for switching between cancellation of dominant N1 and N2 tones.

In some aspects, controller 302 switches CFG 310A and 310B phase/magnitude to control N1 and N2 vibrations based upon one or more conditions, including a flight condition. For example, if an airplane is in take-off or cruising, N1 may be louder or dominate. During landing, N2 may be louder or dominate. Controller 302 instructs CFGs 310A and 310B to cancel the dominant N1 or N2 vibration based upon the dominant (greatest in magnitude) frequency based upon reference and detection signals from sensors. In other aspects, each CFG 310A and 310B has a servo control system housed therein for speeding or slowing the motor of each CFG depending upon different factors, such as flight condition, etc. In further aspects, speed of each CFG 310A and 310B is manually switched. Notably, either controller 302 and/or CFGs 310A and 310B undergo a decision making process for switching motor speed back and forth thereby cancelling N1 and/or N2 speeds at different times and/or according to different flight conditions.

In some aspects, a single controller 302 is used to control a single CFG 310 per engine. Controller 302 is configured to determine whether vibration and/or noise caused by N1 or N2 engine vibration is dominant, and use the single CFG 310 to control vibration at that level. Individual CFGs 310A and 310B are configured to switch between controlling N1 and N2 vibration as instructed via controller 302.

In some aspects, controller 302 provides the decision regarding which frequency to operate CFGS 310 based upon one or more possible conditions or criteria. For example and referring to the example of a jet aircraft, controller 302 is configured to make a decision regarding the frequency at which CFGs 310 operate based upon information regarding the dominant N1 or N2 tachometer frequencies; information available on an aircraft digital bus (e.g., ARINC429) such as engine thrust, altitude, airspeed, angle of attack, etc.; and/or a manually pilot selectable cockpit switch.

As FIG. 3 further illustrates, system 300 may further include one or more optional input sources and/or output sources in electrical communication therewith. For example, system 300 may optionally include a cockpit interface 312 for receiving manual instructions or signals from a pilot within the cockpit. Such signals may be communicated via a digital bus, interface, or data link 308. System 300 may also comprise an optional maintenance interface 314, optional discrete inputs 316, and optional relay outputs 318. Controller 302 is lightweight, dimensionally compact, and includes an advantageous low power design configured to receive and use approximately 28 VDC from an aircraft power supply or power source 320. Each CFG 310A and 310B is also configured to receive approximately 28 VDC of power either from power source 310 directly or through controller 302.

FIG. 3 includes an ANVC system 300 including sensors (e.g., 304, 306) for detecting different vibration tones within an aircraft. For example, the different vibration tones include at least an N1 fan vibration tone and an N2 compressor vibration tone associated with an aircraft engine. Controller 302 is in electrical communication with the sensors, and includes a hardware processor and memory element for processing the different vibration tones detected by the sensors and isolating individual vibration tones. CFGs 310 are in electrical communication with controller 302, and only one individual CFG 310A and 310B is provided per aircraft engine. Each individual CFG 310A and 310B is configured to produce a force for substantially cancelling only one individual tone (e.g., N1 or N2) of the different vibration tones.

As noted above, controller 302 applies one or more conditions for instructing the one CFG per engine to cancel the N1 and N2 vibration tones. The conditions may include (i) determining whether the N1 or the N2 vibration tone is a dominant tone within the aircraft cabin and cancelling the dominant tone; (ii) determining whether the N1 or the N2 vibration tone is more uncomfortable to passengers and cancelling the most uncomfortable tone; (iii) determining a flight condition and cancelling the tone that commonly dominates a given flight condition. Any condition can be applied by controller 302 for controlling noise and vibration within an aircraft. In some aspects, a pilot can manually switch between controlling N1 and N2 vibration tones.

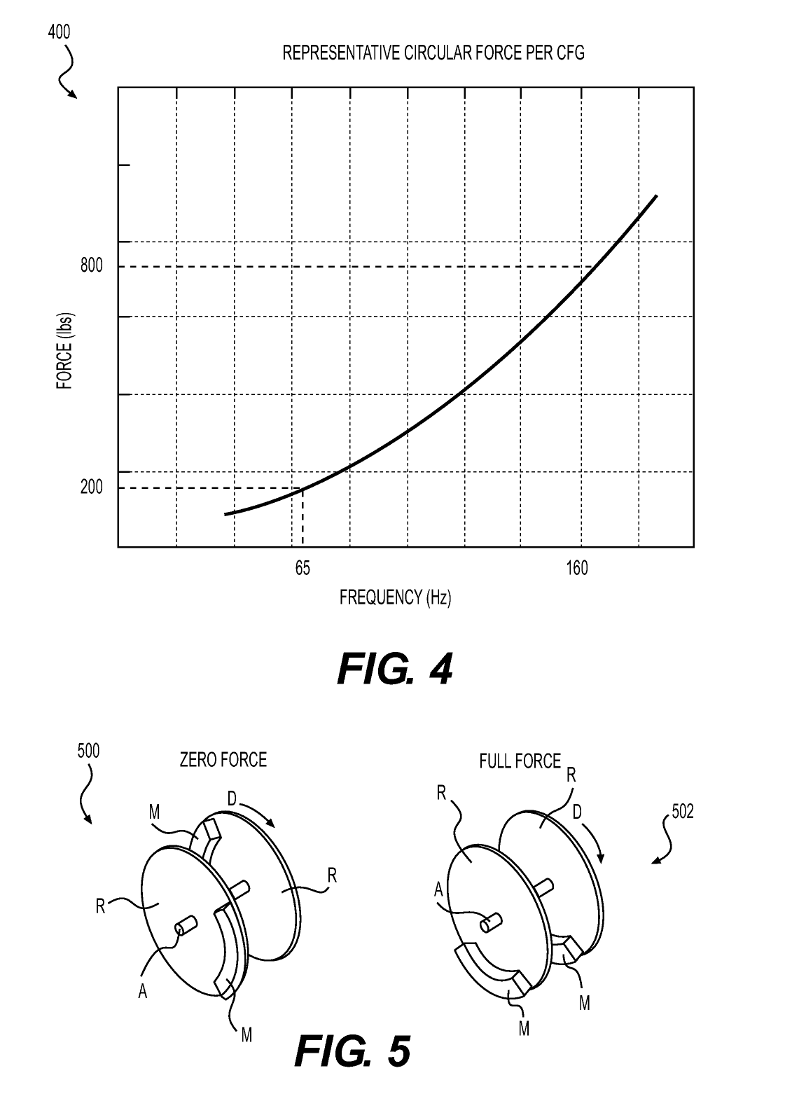

FIG. 4 is a graph, generally designated 400, illustrating a representative circular force generated per CFG (e.g., in any one of systems 100, 200, or 300 as previously described). In some aspects, one CFG produces a circular force of varying magnitude. Phasing of imbalance masses controls force magnitude, phase, and direction. Notably, each CFG is operable for generating both lower frequency forces (e.g., approximately 65 Hz to 80 Hz) for cancelling N1 vibration associated with a rotating motor fan and higher frequency forces (e.g., approximately 140 Hz to 160 Hz) for cancelling N2 vibrations associated with a rotating motor compressor. CFGs are configured to rotate eccentric masses for providing omnidirectional (non-linear) vibration control in at least one or more spherical vectors.

As described with respect to FIGS. 1 to 4, CFGs are configured to generate rotational forces that are omnidirectional in response to the vibrating force detected via sensors. The subject matter herein avoids calculating linear forces and outputting such. CFGs are affixed or coupled to the vibrating structure in positions capable of imparting a vibratory and/or noise cancelling force. Each CFG is controlled by one or more controllers to produce a rotating force with a controllable rotating force magnitude and a controllable rotating force phase. In the jet aircraft example, the CFG or rotary actuators used for controlling vibration and/or acoustical noise may be located on the engine, the engine nacelle or yolk, the wing (for wing mounted engines), or directly on the fuselage structure. In the turboprop aircraft example, the CFG or rotary actuators used for controlling vibration and/or acoustical noise may be located on the propeller, the engine, the engine nacelle, the propeller shaft, the wing (for wing mounted engines), or directly on the fuselage structure. Other mounting locations are also considered where a particular vibration or acoustical noise is to be eliminated.

CFGs are controllable between a minimal force magnitude and a maximum force magnitude. In some aspects, each CFG is mechanically affixed or coupled to the structure wherein the produced rotating force is transferred to the structure with the controllable rotating force phase being controlled and adjusted in response to the sensor data until the vibration and/or acoustical noise data is reduced to a predetermined threshold level.

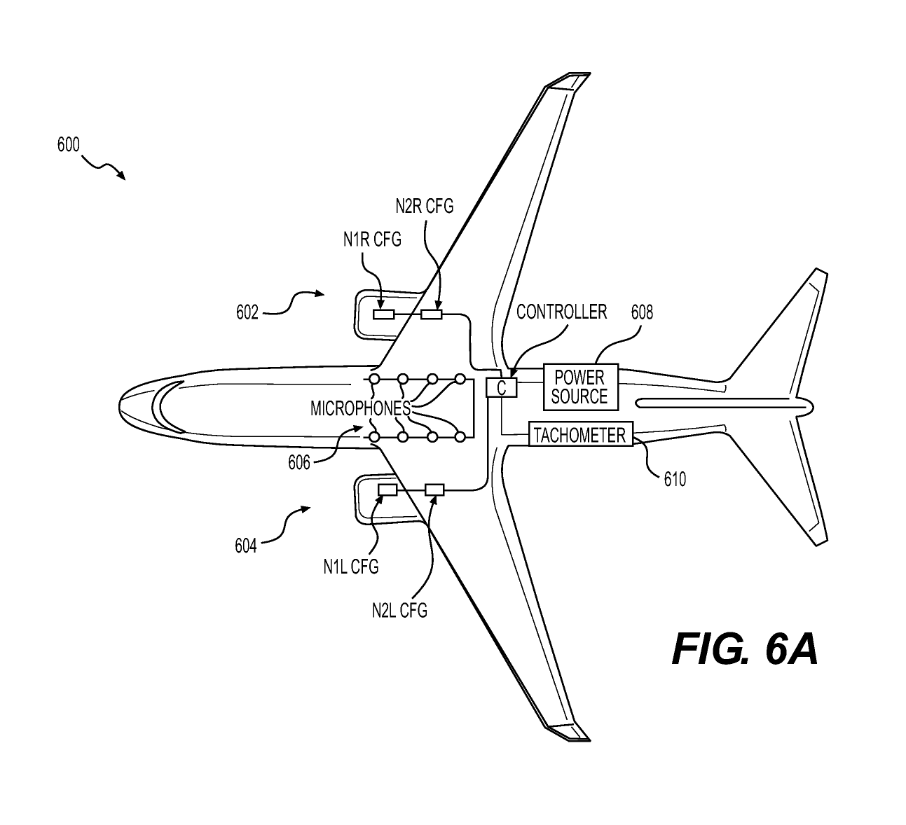

For example and as illustrated in FIG. 5, vibration control devices or CFGs generally designated 500 and 502, include imbalance masses M. The left hand side of FIG. 5 schematically illustrates CFG 500 in a zero force position and the right hand side of FIG. 5 schematically illustrates CFG 502 in a full force position. In the zero force position, masses M produce 0 magnitude forces with 180° mass separation. In the full force position, masses M produce a maximum force magnitude with 0° mass separation. The mass M positions (e.g., separations), speed, phase, and frequency of rotation are controlled by a controller as previously described. Masses M can rotate over a rotor R of a motor and about an axis A. As FIG. 5 illustrates, masses M may co-rotate in a same direction D about axis A.

As previously described, vibration and/or acoustical noise are reduced at frequencies correlating to sensor data input. For the case of the N1 fan and the N2 compressor from the jet engines the vibrations and resulting acoustical noises are preferably reduced at harmonics associated with the fan and high-speed compressor. The CFG generates a cancelling force by driving rotating masses M at the vibratory harmonic and/or acoustical noise of the structure. Vibration cancelling forces are rotational and omnidirectional when two or more CFGs are paired.

In the previously described systems (e.g., 100, 200, and 300), a controller calculates in reference to the reference sensors a rotating force with a real part and an imaginary part. Each CFG 500 and 502 includes at least first and second co-rotating masses M controllably driven about a rotation axis A. The first rotating mass is controllably driven about axis A with at a first rotation imbalance phase and the second co-rotating mass is controllably driven about axis A with a second rotating imbalance phase. Together, the masses generate omnidirectional circular forces for cancelling forces at different frequencies.

Referring to FIGS. 6A and 6B and as applied to the example jet aircraft, an embodiment is illustrated with an ANVC system 600 controlling an interior noise and vibration associated with a right engine 602 and a left engine 604. Each engine produces N1 fan and N2 high-speed compressor vibration. System 600 includes a controller C receiving input from multiple sensors including microphones 606 for detecting acoustical noise and a tachometer 610 detecting N1 and N2. Controller C also receives power from an aircraft power source 608.

As illustrated by FIGS. 6A and 6B, controller C implements vibration control by outputting force commands or signals to a plurality of CFGs mounted at each side of eth aircraft. Controller C communicates to two CFGs at the right engine 602 designated N1R CFG and N2R CFG for cancelling N1 and N2 vibration, respectively. Controller C also communicates to two CFGs at the left engine 604 designated N1L CFG and N2L CFG for cancelling N1 and N2 vibration, respectively.

In other aspects and as described in FIG. 3 above, a single CFG may be provided at each engine and switched to control both the N1 and N2 vibration at different times. The single CFG may be manually switched or switched as determined by an algorithm implemented at a controller or a servo controller of CFG. The algorithm may switch the speed of the CFG for controlling N1 and N2 vibration based upon flight condition, based upon time, or upon determining the dominant vibration. More than two CFGs can be provided per each engine where desired.

In the jet aircraft example of FIGS. 6A and 6B, the CFGs (e.g., N1R CFG, N2R CFG, N1L CFG, and N2L CFG) or rotary actuators may be differently sized. The CFGs (e.g., N1R CFG, N2R CFG, N1L CFG, and N2L CFG) or rotary actuators are used to control higher frequency vibration and/or acoustical noise in addition to the mid-frequency and low-frequency vibration and/or acoustical noise. The CFGs (e.g., N1R CFG, N2R CFG, N1L CFG, and N2L CFG) or rotary actuators are able to control vibrations and/or acoustical noise at multiple frequencies, also referred to as N1 and N2 tones.

Referring to FIGS. 6A and 6B, additional CFGs (not shown) can be added. In this case, multiple CFGs are individually spinning at different speeds to control the noise and or vibration at multiple frequencies. Controller C (or controllers C in a configuration not illustrated) determines the frequencies each CFG would control by using sensor 108 data that is based on the noise and or vibration measurements, as well as the frequencies of the tones that are being controlled and sensed via the feedforward tachometer signal.

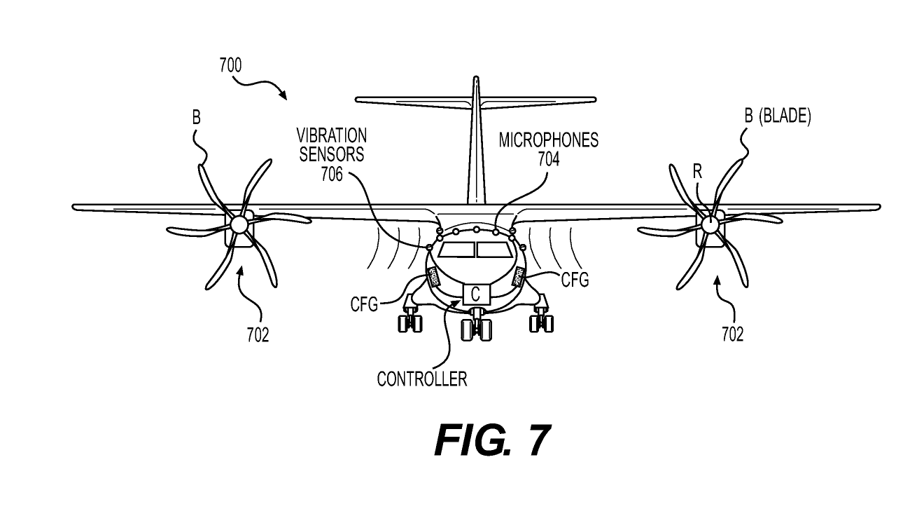

FIG. 7 is a front view of a turboprop aircraft having an ANVC system, generally designated 700, for controlling vibrations and noise associated with one or more turboprop engines, generally designated 702. In turboprop aircraft, vibration is generally produced at a speed related to the propeller speed, as well as at multiples of the propeller speed times the number of propeller blades B. System 700 includes a controller C receiving input from multiple sensors including microphones 704 for detecting acoustical noise and vibration sensors 706 for detecting vibration (depicted in curved lines). Controller C receives and processes inputs, including information received from microphones 704 and sensors 706, and then outputs force commands to one or more CFGs, shown on opposing sides of the aircraft. Vibration sensors 706 may be disposed on the fuselage structure and microphones 704 may be provided inside the fuselage cabin.

When used on turboprop aircraft, the CFGs can produce forces to reduce vibration at the propeller speed. They can then be configured to produce forces that can reduce noise generated at a frequency of the propeller speed times the number of blades B (i.e., called the blade pass frequency). On turboprop aircraft, at least one reference sensor per propeller may be required (e.g., a tachometer that is frequency related to the main rotor speed times the number of blades for each engine 702).

Although not illustrated in the Figures, in an example of a hovercraft powered by at least one jet engine or turboprop engine, the hovercraft will use a configuration as described for the jet aircraft above or the turboprop aircraft above. Additionally, by using multiple CFGs individually spinning at different speeds control of the noise and or vibration at multiple frequencies is provided for the hovercraft. In this case, the controller determines the frequencies each CFG would control, based on the noise and or vibration measurements, as well as the frequencies of the tones that are being controlled and sensed via the feedforward tachometer signal.

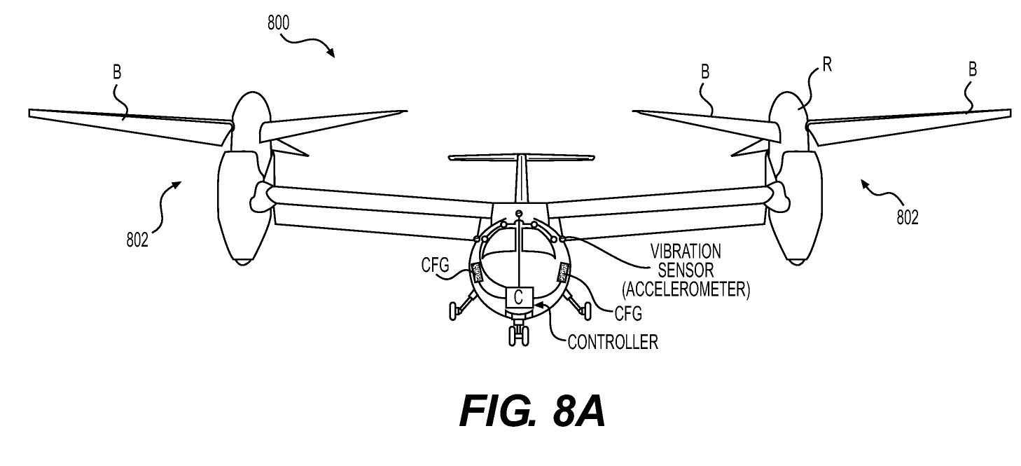

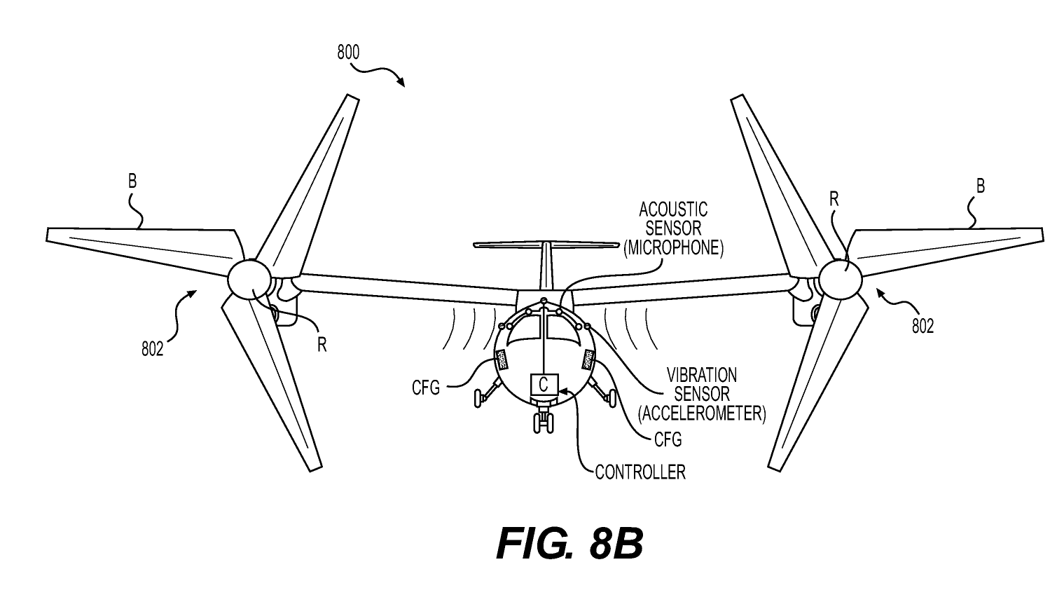

FIGS. 8A and 8B illustrate front views of a tiltrotor aircraft having an ANVC system, generally designated 800, for controlling vibrations and noise associated with one or more tiltrotor engines, generally designated 802. Tiltrotors engines 802 are operable in a helicopter mode, as illustrated by FIG. 8A and in an airplane mode as illustrated by FIG. 8B. As illustrated by FIGS. 8A and 8B, system 800 includes a controller C, one or more sensors (e.g., accelerometers), one or more microphones (e.g., acoustic sensors), and one or more CFGs. Vibration sensors may be disposed on the fuselage structure and microphones may be provided inside the fuselage cabin.

In helicopter mode illustrated by FIG. 8A, vibration is primarily produced at a frequency equal to a main rotor R speed of tiltrotor engines 802 multiplied by the number of blades B. In airplane mode illustrated by FIG. 8B, the primary effect of the vibration is creation of pressure waves (depicted by curved lines), which hit the fuselage (e.g., like a propeller aircraft) and result in interior noise. In this situation, the CFGs may preferably control vibration during helicopter mode (FIG. 8A) and may preferably control interior noise during airplane mode (FIG. 8B). Vibration sensors are used for control during helicopter mode (FIG. 8A) while interior microphones are used for control during airplane mode (FIG. 8B). System 800 determines whether the aircraft is operable in airplane mode or helicopter mode by detecting changes in the rotor R speed, receiving information from the aircraft data bus, or manually from a switch (discrete input). On a tiltrotor aircraft, only a single reference sensor may be required (e.g., a tachometer that is frequency related to the main rotor speed times the number of blades B).

Other embodiments of the current subject matter will be apparent to those skilled in the art from a consideration of this specification or practice of the subject matter disclosed herein. Thus, the foregoing specification is considered merely exemplary of the current subject matter with the true scope thereof being defined by the following claims.

What is claimed is:

1. An active noise and vibration control (ANVC) system, the system comprising:
a plurality of sensors configured to detect vibration of a structure;
a controller in electrical communication with each of the plurality of sensors, the controller comprising a hardware processor and a memory element configured to process the vibration detected by the plurality of sensors, generate a force control command signal, and output the force control command signal via an interface; and
at least one circular force generator (CFG) in electrical communication with the controller, wherein the CFG is configured to execute the force control command signal output from the controller and produce a force that substantially cancels the vibration force.

2. The ANVC system of claim 1, wherein the plurality of sensors comprises a plurality of accelerometers positioned to detect a known vibration from a component mechanically attached to the structure.

3. The ANVC system of claim 1, wherein the plurality of sensors comprises a tachometer or rotor speed sensor positioned to detect a known vibration speed from a component mechanically attached to the structure.

4. The ANVC system of claim 1, further comprising a plurality of detection sensors configured to detect an acoustic noise caused by vibration of the structure.

5. The ANVC system of claim 4, wherein the detection sensors comprise a plurality of microphones.

6. The ANVC system of claim 4, wherein said force produced by said CFG is capable of substantially canceling at least one vibration force causing said acoustical noise.

7. The ANVC system of claim 1, wherein the structure is a jet aircraft.

8. The ANVC system of claim 1, wherein the structure is a semi-truck.

9. The ANVC system of claim 1, wherein the structure is a ship.

10. The ANVC system of claim 1, wherein the structure is a building.

11. The ANVC system of claim 1, wherein the structure is a helicopter.

12. The ANVC system of claim 1, wherein the structure is a train.

13. The ANVC system of claim 1, wherein the structure is a turboprop aircraft.

14. The ANVC system of claim 1, wherein the structure is a tiltrotor aircraft.

15. The ANVC system of claim 1, wherein the system further comprises multiple controllers that are digitally linked.

16. An active noise and vibration control (ANVC) system, the system comprising:
a plurality of sensors configured to detect vibration of a structure;
a controller in electrical communication with each of the plurality of sensors, the controller comprising a hardware processor and a memory element configured to process the vibration detected by the plurality of sensors; and
at least one circular force generator (CFG) in electrical communication with the controller, wherein the CFG is configured to co-rotate a pair of eccentric masses at a first frequency during a first time and at a second frequency, that is different from the first frequency, during a second time for controlling different frequencies of vibration during a flight.

17. The ANVC system of claim 16, wherein the plurality of sensors comprises a plurality of accelerometers positioned to detect a known vibration from a component mechanically attached to the structure.

18. The ANVC system of claim 16, wherein the plurality of sensors comprises a tachometer positioned to detect a known vibration from a component mechanically attached to the structure.

19. The ANVC system of claim 16, further comprising a plurality of detection sensors configured to detect acoustic noise caused by the vibration of the structure.

20. The ANVC system of claim 19, wherein the detection sensors comprise a plurality of microphones.

21. The ANVC system of claim 19, wherein said force produced by said CFG is capable of substantially canceling at least one vibration force causing said acoustical noise.

22. The ANVC system of claim 16, wherein the structure is a jet aircraft.

23. The ANVC system of claim 16, wherein the structure is a tiltrotor aircraft.

24. The ANVC system of claim 16, wherein the structure is a turboprop aircraft.

25. A method of controlling acoustic noise and vibration, the method comprising:
providing a plurality of sensors for detecting vibration of a structure;
digitally linking each sensor of the plurality of sensors with a controller, wherein the controller comprises a hardware processor and a memory element configured to process the vibration detected by the plurality of sensors, generate a force control command signal, and output the force control command signal via an interface; and
spinning a pair of eccentric masses within a rotary actuator according to the force control command signal output from the controller for producing a force that substantially cancels the vibration force.

26. The method of claim 25, wherein providing a plurality of sensors includes affixing a pair of accelerometers to an aircraft engine.

27. The method of claim 25, wherein providing a plurality of sensors includes affixing a tachometer to an aircraft engine.

28. The method of claim 25, wherein the speed, phase, frequency, and magnitude at which the eccentric masses spin is specified by the force control command signal.

29. The method of claim 25, further comprising spinning the pair of eccentric masses at different frequencies for substantially cancelling different frequencies of vibration.

30. The method of claim 25, further comprising providing a plurality of microphones for detecting noise associated with the vibrating structure.

31. An active noise and vibration control (ANVC) system, the system comprising:
one or more sensors configured to detect different vibration tones within an aircraft;
a controller in electrical communication with the sensors, the controller comprising a hardware processor and a memory element configured to process the different vibration tones detected by the sensors and isolate individual vibration tones; and
one or more circular force generators (CFGs) in electrical communication with the controller, wherein only one CFG is provided per aircraft engine, and wherein the one CFG is configured to produce a force for substantially cancelling one individual tone of the different vibration tones.

32. The ANVC system of claim 31, wherein the different vibration tones include at least an N1 fan vibration tone and an N2 compressor vibration tone associated with an aircraft engine.

33. The ANVC system of claim 31, wherein the controller applies one or more conditions for instructing the one CFG per engine to cancel either the N1 or the N2 vibration tones.

34. The ANVC system of claim 33, wherein the conditions include:
(i) determining whether the N1 or the N2 vibration tone is a dominant tone within the aircraft cabin and cancelling the dominant tone;
(ii) determining whether the N1 or the N2 vibration tone is more uncomfortable to passengers and cancelling the most uncomfortable tone; and
(iii) determining a flight condition, and cancelling the N1 or the N2 vibration tone that dominates a given flight condition.

35. The ANVC system of claim 31, wherein the controller is configured to determine whether an aircraft is operable in a helicopter mode or an airplane mode, and instruct the one CFG to control vibration associated with a tiltrotor when in the helicopter mode, and noise when in the airplane mode.
